(19) United States
(12) Patent Application Publication
(10) Pub. No.: US 2005/0170183 A1
(43) Pub. Date: Aug. 4, 2005

(54) Substituted polyarylether molded body, method for the production thereof and use of the same

(75) Inventor: Arne Gehlen, Johannesburg (DE)

Correspondence Address: OLIFF & BERRIDGE, PLC, P.O. BOX 19928, ALEXANDRIA, VA, 22320, US

(73) Assignee: MEMBRANA GMBH, Wuppertal (DE)

(21) Appl. No.: 10/512,452

(22) PCT Filed: Apr. 16, 2003
(86) PCT No.: PCT/EP03/03949

(51) Int. Cl. B32B 31/06; B05D 1/18

(52) U.S. Cl. 428/409; 428/411.1; 428/420; 427/430.1

(57) ABSTRACT

A molded body containing a polyarylether, at the surface of which substituents of formula —(R₁—C—R₂)—X are bound, where R₁═H or an alkyl residue with 1 to 4 C atoms, R₂═H or an alkyl residue with 1 to 4 C atoms, and X is a residue of formula NH—(O═C)—CH₂-A, where A=F, Cl, Br or I or (CH₂)ₚCHNH₂—COOH with p=1 or 2, or a residue of formula NH—(CH₂)ₙ—CH₂—Y, where Y═H or NH₂ and n is an integer between 0 and 6, or a residue of formula O—(CH₂)ₘCH₂-Z, where Z=H, OH, COOH, NH₂, N-pyrrolidone or N-pyrrolidine and m is an integer between 1 and 5, or a residue of formula NH—NH—(C═NH)—NH₂, or a residue of formula NH—(O═C)—CR₃═CH₂ where R₃═H or CH₃, or a residue of formula O—(O═C)—(CH₂)ₖ-L, where L=COOH or NH₂ and k is an integer between 1 and 10, or a residue of formula NH—(O═C)-Ph, where Ph is an unsubstituted or pentahalogenated phenyl residue, or a residue of formula O-G, where G is a glucose residue or glucosamine residue. Also the method for producing such a molded body.

### CROSS-REFERENCE TO RELATED APPLICATION

The present application is a U.S. National Stage application of International Application No. PCT/EP03/03949 filed on Apr. 16, 2003.

### BACKGROUND OF THE INVENTION

1. Field of the Invention

The present invention relates to a substituted polyarylether molded body, a method for its production and its uses.

2. Description of Related Art

EP-B-0 540 592 describes a molded body of polysulfone (PSu), polyethersulfone (PES) or polyetherketone (PEK), which in a first reaction step is crosslinked and sulfonated. Sulfonic acid groups, hydroxymethyl groups and ether groups are present side by side on the surface of the crosslinked and sulfonated molded body. The molded body that has been modified in this way is reacted downstream with compounds containing hydroxyl or carbonyl groups, condensable aromatic compounds or other compounds that enter into reactions with the groups present on the surface of the molded body, i.e. the sulfonic acid, hydroxymethyl and ether groups. This results in a PSu, PES or PEK molded body that has been modified at the available groups by the above-mentioned compounds, and, because no reaction goes entirely to completion, also contains the unreacted sulfonic acid, hydroxymethyl and ether groups. The crosslinked molded body therefore contains a plurality of different functional groups and cannot provide the specific effect desired for certain applications, such as adsorption chromatography. Moreover, the free sulfonic acid groups detract from the biocompatibility of the molded body. Finally, a method of producing the substituted molded body is carried out in two stages and is therefore costly.

### SUMMARY OF THE INVENTION

The object of the present invention is therefore to provide a specifically substituted polyarylether molded body that has no sulfonic acid groups and can be produced more easily.

This object is achieved by a molded body containing a polyarylether, at the surface of which substituents of formula (I) 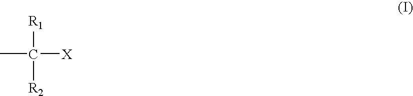
are bound, where R₁═H or an alkyl residue with 1 to 4 C atoms, R₂═H or an alkyl residue with 1 to 4 C atoms, and X is a residue of formula (a) 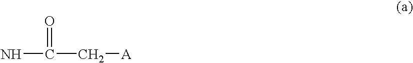
where A=F, Cl, Br or I or (CH2)ₚCHNH₂—COOH with p=1 or 2, or
a residue of formula (b)
   NH—(CH₂)ₙ—CH₂—Y (b)
   where Y═H or NH₂ and n is an integer between 0 and 6, or
a residue of formula (c)
   O—(CH₂)ₘCH₂-Z (c)
   where Z=H, OH, COOH, NH2, N-pyrrolidone or N-pyrrolidine and m is an integer between 1 and 5, or
a residue of formula (d) 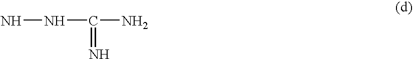
   or
a residue of formula (e) 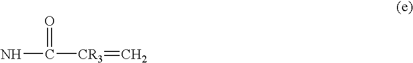
   where R₃═H or CH₃, or
a residue of formula (f) 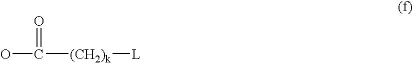
   where L=COOH or NH₂ and k is an integer between 1 and 10, or
a residue of formula (g) 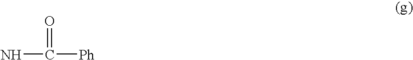
   where Ph is an unsubstituted or pentahalogenated, preferably pentafluorinated, phenyl residue, or
a residue of formula (h)
   O-G (h)
   where G is a glucose residue or glucosamine residue.

The molded body of the invention is therefore specifically substituted in every case by only one substituent of formula (I) at the surface of the polyarylether. The molded body of the invention therefore provides the specific effect required for particular applications, such as adsorption chromatography. Moreover, the molded body of the invention contains no sulfonic acid groups.

In the molded body of the invention, R₁ and R₂ can be, independently of each other, H or an alkyl residue with 1 to 4 C atoms, i.e. a methyl, ethyl, propyl or butyl residue, where it is preferred for steric reasons that R₁═R₂═H or R₁═R₂═CH₃ or R₁═H and R₂═CH₃.

The molded body of the invention can fundamentally be in any form in which molded bodies containing polyarylethers can exist. It is preferably in the form of a powder and more preferably in the form of a porous powder because the surface area available for interaction with fluids is then especially large. This is desirable, for example, when the powder is used as a separation medium, such as the packing material of a chromatographic column. Those skilled in the art can select without difficulty appropriate values for particle size, pore diameter, and pore distribution over the cross-section of the particle, for any specific separation problem.

Another preferred form in which the molded body of the invention can exist is that of a hollow or flat membrane, which, preferably has pores for the size range and the spatial distribution over the membrane cross-section, for any specific separation problem.

Various molded bodies containing a polyarylether, a molded body whose polyarylether is a polysulfone (PSu), polyethersulfone (PES), polyetherethersulfone (PEES), polyetherketone (PEK), polyetheretherketone (PEEK) or a copolymer of the preceding polymers, preferably a PES/PEES copolymer, being preferred on account of the good chemical and thermal stability of the above polyarylethers are well known in the art. Examples of suitable polyarylethers include the PSu available under the tradename Udel® from Solvay Advanced Polymers, the PES available under the tradenames Ultrason® from BASF or Sumi KA EXCEL from Sumitomo, the PES/PEES copolymer available under the tradename Radel As from Solvay Advanced Polymers with 10% hydroquinone units, and the polyetheretherketone available under the tradename PEEK® from Victrex®.

The molded body of the invention can in principle consist entirely of a polyarylether. In many cases, however, the molded body of the invention contains a polyarylether and other components known to be used for its production. For example, a polyethersulfone-containing membrane can contain polyvinylpyrrolidone.

If the molded body of the invention is in nonporous form, the term “surface” necessarily means the geometric outer surface. For a porous molded body, the term “surface” includes, for the purposes of the invention, the geometric outer surface as well as the surface of the pores, which is generally very much greater than that of the geometric outer surface of the molded body.

In a molded body of the invention, a substituent of formula (I) a)-h) is bound to aromatic rings of the respective polyarylether, these rings being located on the surface, as defined above, of the molded body containing the respective polyarylether. The substitution can be verified by dissolving the molded body of the invention that contains the polyarylether in, e.g., DMSO-d₆, and obtaining a ¹H NMR spectrum of the solution. For example, in a molded body of the invention that contains PEES and is substituted as in formula (I) a) with 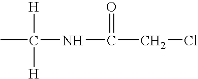
signals are observed from 1,2,4-substituted aromatic moieties at 7.08 ppm and 6.95 ppm, and from the introduced methylene groups in the range 3.9-4.5 ppm.

The object of the invention is further achieved by a method for producing a molded body containing a substituted polyarylether, characterized in that aqueous H₂ SO₄ is provided, an agent of formula HX, where X is in every case a residue of formula (a), (b), (c), (d), (e), (f), (g) or (h) as described above, is added to aqueous H₂SO₄, and a carbonyl compound of formula (II) 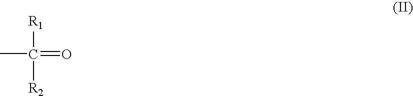
or a linear or cyclic ether of formula (III) a) or (III) b) 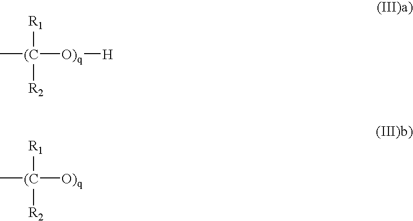
is dissolved in the resulting solution, where R₁ and R₂ are as recited in claim 1, and q=3 to about 10000, the upper limit of q being determined by a sufficient speed of dissolution of the ether in the sulfuric acid. A reaction solution is thus obtained, which is then used to treat the molded body containing a polyarylether.

In a preferred embodiment of the method of the invention, the carbonyl compound is formaldehyde or acetaldehyde.

In a further preferred embodiment of the method of the invention, the ether is paraformaldehyde or trioxane.

As the agent of formula HX, iodoacetamide, hexylamine, hexamethylene diamine, ethanol, glucose, glucosamine, benzamide, pentafluorobenzamide, N-(2-hydroxyethyl)-pyrrolidone, N-(2-hydroxyethyl)-pyrrolidine or aminoguanidine are preferably used in the method of the invention, the last-named preferably as the hydrochloride. These agents give a particularly high yield. In contrast, the aminoguanidine-like diaminoguanidine (DAG) is not suitable as agent H—X and does not give the desired product.

Surprisingly, the action of the reaction solution described above on the molded body containing a polyarylether results in a molded body of the invention that is substituted with a particular substituent of formula (I) (a), (b), (c), (d), (e), (f), (g) or (h), depending on the agent HX used, and is therefore specifically substituted. It is also surprising that the substituted molded body produced by the method of the invention herein contains no sulfonic acid groups. The known test using methylene blue for the presence of these groups, which is also described in EP-B 0 540 592, gives a negative result. Another surprising finding is that the molded body produced by the method of the invention is completely soluble and therefore not crosslinked. Finally, it is surprising that the molded body substituted in accordance with the invention is obtained very simply, in a one-step reaction, by the method of one invention.

### DETAILED DESCRIPTION OF THE INVENTION

In one method of the invention, the reaction solution can in principle be used to treat a molded body that is in any form and contains a polyarylether. The reaction solution is preferably reacted with a molded body, containing a polyarylether, that is present in the form of a powder, it being especially preferred, for the reasons stated above, that the powder be porous.

In a further preferred embodiment of the method of the invention, the reaction solution can be used to treat a molded body that is in the form of a hollow or flat membrane and contains a polyarylether, the molded body especially preferably being porous.

If, in another preferred embodiment of the method of the invention, the reaction solution is used to treat a molded body of which the polyarylether is a polysulfone (PSu), polyethersulfone (PES), polyetherethersulfone (PEES), polyetherketone (PEK), polyetheretherketone (PEEK) or a copolymer of these polymers, preferably a PES/PEES copolymer, a substituted molded body is obtained that has a polyarylether component with good chemical and thermal stability. Examples of tradenames and supply sources for suitable polyarylethers have been cited above.

It is possible in principle in one method of the invention to use the reaction solution to treat a molded body consisting entirely of a polyarylether. In many cases, however, the molded body of the invention contains a polyarylether and other components known to be used in its production. A membrane containing polyethersulfone, for example, also contains polyvinylpyrrolidone.

In one method of the invention a molded body containing a polyarylether is obtained, in which a substituent of formula (I) (a), (b), (c), (d), (e), (f), (g) or (h) is bound to aromatic rings of the respective polyarylether, these substituted rings being located on the surface, as defined above, of the molded body. As has been stated above, the substitution can be verified by ¹H NMR spectroscopy.

In one method of the invention, the aqueous H₂SO₄ used is preferably at a concentration of 60 to 93 wt. % and especially preferably of 80 to 90 wt. %.

In one method of the invention, the agent HX is dissolved in the H₂SO₄ in such quantity that the molar ratio of HX to H₂SO₄ lies preferably between 0.001 and 1, and especially preferably between 0.05 and 0.5.

For preparation of the reaction solution in one method of the invention, it is of course possible to use the preferred formaldehyde or trioxane or paraformaldehyde in solution, e.g., in water. However, it is preferable to dissolve the formaldehyde or trioxane or paraformaldehyde as the pure substance in each case in the solution comprising HX and aqueous H₂SO₄.

In another preferred embodiment of one method of the invention, formaldehyde or trioxane or paraformaldehyde and HX are used in such quantities that the molar ratio of formaldehyde or O—CH₂) to H—X lies between 0.1 and 1.0, a ratio between 0.33 and 0.50 being especially preferred. —(O—CH₂)— is here the effective structural unit of the trioxane or paraformaldehyde in one method of the invention.

Furthermore, formaldehyde or trioxane or paraformaldehyde and H₂SO₄ are used, in one method of the invention, in such quantities that the molar ratio of formaldehyde or O—CH₂y to H₂SO₄ lies between 0.001 and 0.50, a ratio between 0.01 and 0.08 being especially preferred.

The reaction solution in one method of the invention can be prepared at temperatures above room temperature. For many of the reactants of the invention, however, the reaction solution can be prepared sufficiently rapidly even at room temperature, for which reason this temperature is preferred for preparation of the reaction solution. Furthermore, the reaction solution can also be prepared in one method according to one embodiment of the invention at a temperature below room temperature, provided that the components dissolve sufficiently rapidly at this temperature.

The treatment of the polyarylether-containing molded body with the reaction solution can in principle be carried out by any method guaranteeing that the surface of the molded body is in contact with the reaction solution. The molded body can, for example, be immersed in the reaction solution.

The rapidity with which a desired degree of substitution is attained depends also on the temperature at which the molded body is treated with the reaction solution. If the polyarylether-containing molded body is treated with the reaction solution at a temperature between 30° C. and the boiling point of the reaction solution, the substitution of the invention occurs sufficiently rapidly, for which reason this temperature range is preferred in the method of the invention.

Depending on the type of substituent in formula (I), the molded body of the invention or produced by the method of the invention can be used for a plurality of purposes in which a specific effect is desired.

These include adsorption chromatography, if the molded body carries in each case a substituent of formula (I) (a) or (I) (b) with the exception of Y═H, or (I) (c) with the exception of Z=H, or (I) (f). For example, a molded body substituted with a substituent of formula (I) (a) where A is a halogen can be used for covalent binding of di- and/or triaminoguanidine. The molded body modified in this way can in turn be used to remove precursors of AGE (advanced glycation endproducts) from blood, so that the formation of AGE, the cause of such diseases as arteriosclerosis and amyloidosis, can be inhibited. A molded body carrying a substituent of formula (I) (a), where A is an acid of formula (CH₂)ₚCHNH₂—COOH with p=1 or 2, can be used for removal by adsorption chromatography of basic molecules. A molded body carrying a substituent of formula (I) (b), where Y═NH₂, can be used for removal by adsorption chromatography of acidic molecules. A molded body carrying a substituent of formula (I) (c) can be used for removal by adsorption chromatography of molecules that react specifically with the respective end-group Z of the substituent, i.e., with the OH, COOH, NH₂, N-pyrrolidone or N-pyrrolidine groups. A molded body carrying a substituent of formula (I) (f) can be used, depending on whether L=COOH or L=NH₂, for removal by adsorption chromatography of basic or acidic groups.

Moreover, a molded body according to one embodiment of the invention or produced by the method according to one embodiment of the invention and having a substituent of formula (I) (a) can be used for reaction with a nucleophile. The preferred nucleophile is an aliphatic amine, diaminoguanidine, an amino acid, a peptide or an alcohol.

A molded body according to one embodiment of the invention or produced by the method according to one embodiment of the invention having a substituent of formula (I) (d) can advantageously be used as an anion exchanger.

A molded body according to one embodiment of the invention or produced by the method according to one embodiment of the invention having a substituent of formula (I) (e) can advantageously be used for graft copolymerization.

A molded body according to one embodiment of the invention or produced by the method according to one embodiment of the invention having a substituent of formula (I) (g) or of formula (I) (b) with Y═H can be used to provide a molded body with increased hydrophobicity.

A molded body according to one embodiment of the invention or produced by the method according to one embodiment of the invention having a substituent of formula (I) (h) can be used to provide a molded body with increased hydrophilicity, or for reaction with cyanogen bromide.

The ESCA (electron spectroscopy for chemical application) technique allows determination of the percentage of atoms on the external surfaces of the molded body that carry a substituent. The ESCA technique is preferable because its sensitivity is of the order of only a few nm. A porous molded body has in addition substituents bound to the surface of the pores in the interior of the molded body.

If the molded body carries halomethyl groups, i.e., substituents of formula (I) a) with A=F, Cl, Br or I, it is possible to determine in the following way the density of the substituents on the outer surface and on the surface of the pores in the interior of the molded body. All the halomethyl groups of the molded body are first derivatized with hexamethylene diamine (HMDA). The number (nmol) of the free amino groups is then determined, which corresponds to the nmol of the halomethyl groups. The detailed procedure is as follows:

If the molded body that is substituted with halomethyl groups is in the form of a film or flat membrane, a piece of area 1.13 cm² is punched out with a punch of diameter 12 mm and used for determination of the substitution density per unit area. The term “substitution density per unit area” is in this case the number (nmol) of halomethyl groups per cm² of the punched-out film or membrane surface.

If the molded body that is substituted with halomethyl groups is in the form of a capillary membrane, a piece of length 8 cm is cut off from the capillary and used for determination of the substitution density per unit length. The term “substitution density per unit length” is in this case the number (nmol) of halomethyl groups per cm of capillary length.

For the derivatization, the molded body substituted with halomethyl groups is reacted at 50° C. for 0.5 h with a 5 wt. % aqueous solution of HMDA, whereupon the halomethyl groups react with an amino group of the HMDA. The derivatized molded body is then washed free of excess HMDA with fully demineralized water. To check that the reaction with HMDA was quantitative, the derivatized molded body can be examined for residual halogen by the ESCA technique. For determination of the nmol of free amino groups, the derivatized molded body is placed in a test tube to which 100 μl of fully demineralized water is added, followed by 300 μl of ninhydrin reagent solution from Sigma (of which the composition is given in S. Moore, Biological Chemistry, Vol. 243 (1968), p. 6281). The test tube is covered with a glass bead and heated in a water bath at a temperature of 99.5° C. for 30 minutes. The reaction of the amino groups with ninhydrin produces a compound absorbing at 570 nm. The solution containing this compound is treated with 2 ml of a 1:1 mixture of i-propanol and water, and the absorption at 570 nm is measured using an Agilent 8454 UV-Visible spectrophotometer. Comparison of this absorption with that of calibration solutions of known amino group concentration (calibrant: 6-aminocaproic acid) allows determination of the nmol of the amino groups, and hence the nmol of the halomethyl groups.

The derivatization of the molded body carrying the halomethyl groups can alternatively be carried out in the same way but using diaminoguanidine (DAG) instead of HMDA, and using the DAG derivative as described above for determination of the density of the substituents on the outer surface and on the surface of the pores in the interior of the molded body.

The invention will now be described in more detail with the help of the following examples.

### EXAMPLE 1

### Substitution of a Pes/Pees Copolymer Flat Membrane with Chloroacetamide

A PES/PEES membrane was produced from a solution of 30 wt. % Radel A (a PES/PEES copolymer containing approx. 10% of hydroquinone units), 56 wt. % dimethylacetamide and 14 wt. % polyethylene glycol 200.

14.4 g of chloroacetamide and then 1.0 g of paraformaldehyde were added to and dissolved in 35 ml of 80 wt. % H₂SO₄ at room temperature. Two pieces of the above mentioned PES/PEES membrane, each approximately 10×4 cm, were laid in the resulting reaction solution. The PES/PEES flat membrane was treated with the reaction solution with stirring at a temperature of about 45° C. for approximately 16 hours.

The substituted PES/PEES flat membrane was washed 3 times with fully demineralized water to make it neutral, boiled for about 30 minutes with demineralized water, and dried in a vacuum drying cabinet at 20 mbar and 70° C. for approximately 1 hour. The substituted PES/PEES flat membrane was then dissolved in DMSO-d₆ and a ¹H NMR spectrum was recorded. The spectrum shows peaks from 1,2,4-substituted aromatic moieties at 7.08 ppm and 6.95 ppm, signals from the methylene protons introduced, and a signal from the amido proton at 8.9 ppm. The degree of substitution as calculated from the spectrum is 0.8%. This means that in the solution measured 0.8% of all repeating units of the PES/PEES copolymer carry a CH₂NH(O═C)—CH₂Cl substituent, so that the degree of substitution on the pore surface of the membrane is >0.8%.

From derivatization of the substituted membrane with HMDA and reaction of the derivative with ninhydrin, the substitution density per unit area was determined as 67 nmol of CH₂NH(O═C)—CH₂Cl/cm².

### EXAMPLE 2

### Substitution of a PES Film with Chloroacetamide

A PES film was produced from a 25 wt. % solution of Ultrason E6020 (PES) in dimethylacetamide.

14.4 g of chloroacetamide and then 1.0 g of paraformaldehyde were added to and dissolved in 35 ml of 80 wt. % H₂SO₄ at room temperature. Two pieces of the above mentioned PES film, each approximately 10×4 cm, were laid in the resulting reaction solution. The PES film was treated with the reaction solution with stirring at a temperature of about 45° C. for approximately 16 hours.

The substituted PES film was washed 3 times with fully demineralized water to make it neutral, boiled for about 30 minutes with demineralized water, and dried in a vacuum drying cabinet at 20 mbar and 70° C. for approximately 1 hour.

From derivatization of the substituted PES film with HMDA and reaction of the derivative with ninhydrin, the substitution density per unit area was determined as 50 nmol of CH₂NH(O═C)—CH₂Cl/cm².

### EXAMPLE 3

### Substitution of a Pes/Pees Copolymer Flat Membrane with Hexylamine

10 g of hexylamine and then 1.0 g of paraformaldehyde were added to and dissolved in 35 ml of 80 wt. % H₂SO₄ at room temperature. Two pieces of the PES/PEES copolymer flat membrane produced as in Example 1, each approximately 10×4.5 cm, were laid in the resulting reaction solution. The PES/PEES flat membrane was treated with the reaction solution with stirring at a temperature of about 45° C. for approximately 16 hours.

The substituted PES/PEES copolymer flat membrane was washed 3 times with fully demineralized water to make it neutral, boiled for about 30 minutes with fully demineralized water, and dried in a vacuum drying cabinet at 20 mbar and 70° C. for approximately 1 hour.

The PES/PEES copolymer flat membrane was then dissolved in DMSO-d₆ and a ¹H NMR spectrum was recorded. The spectrum shows peaks between 4.1 and 5 ppm from methylene groups that are directly bound to the aromatic moiety. The membrane therefore contains NH—(CH₂)₅—CH₃ substituents.

### EXAMPLE 4

### Substitution of a PES Film with Aminoguanidine

4.75 g of aminoguanidine hydrochloride and then 1.0 g of paraformaldehyde were added to and dissolved in 35 ml of 80 wt. % H₂SO₄ at room temperature. Two pieces of the PES film produced as in Example 2, each approximately 20×5 cm, were laid in the resulting reaction solution. The PES film was treated with the solution with stirring, initially for approximately 16 hours at room temperature and then for about 96 hours at 45° C.

The substituted PES film was washed 3 times with fully demineralized water to make it neutral, boiled for about 30 minutes with fully demineralized water, and dried in a vacuum drying cabinet at 20 mbar and 70° C. for approximately 1 hour.

The PES film was then dissolved in DMSO-d₆ and a ¹H NMR spectrum was recorded. The spectrum shows a singlet from a 1,3,4-substituted aromatic moiety at 6.95 ppm and 7.05 ppm.

Using ESCA, the degree of substitution can be determined as 0.95±0.05% on the upper surface and 0.62±0.25% on the lower surface of the PES film. This means that 0.95±0.05% of all the atoms on the upper surface and 0.62±0.25% of all those on the lower surface are nitrogen atoms. The reaction with ninhydrin of the PES film having NH—NH—(C═NH)—NH₂ substituents is negative, indicating that no primary amino groups are present. The NH—NH—(C═NH)—NH₂ substituents are therefore bound to the PES film via the hydrazine functional group.

### EXAMPLE 5

### Substitution of a PES Film with Ethanol

4.6 g of ethanol and then 1.0 g of paraformaldehyde were added to and dissolved in 35 ml of 80 wt. % H₂SO₄ at room temperature. Two pieces of PES film produced as in Example 2, each approximately 20×5 cm, were laid in the resulting reaction solution. The PES film was treated with the reaction solution with stirring at a temperature of 45° C. for about 72 hours.

The substituted PES film was washed 3 times with fully demineralized water to make it neutral, boiled for about 30 minutes with fully demineralized water, and dried in a vacuum drying cabinet at 20 mbar and 70° C. for approximately 1 hour.

The substituted PES film was then dissolved in DMSO-d6 and a ¹H NMR spectrum was recorded. The spectrum clearly shows that an ethoxybenzyl ether has been formed. The degree of substitution as calculated from the spectrum is 0.1%. This means that in the solution measured 0.1% of all PES repeating units carry an O—CH₂CH₃ substituent, so that the degree of substitution on the pore surface of the membrane is >0.1%.

### EXAMPLE 6

### Substitution of a PES Film with Iodoacetamide

A PES film was produced from a 25 wt. % solution of Ultrason E6020 (PES) in dimethylacetamide.

6.7 g of iodoacetamide and then 0.35 g of paraformaldehyde were added to and dissolved in 35 ml of 80 wt. % H₂SO₄ at room temperature. A 50 cm² piece of the above PES film was laid in the resulting reaction solution. The PES film was treated with the reaction solution with stirring and at a temperature of 85° C. for about 6 hours.

The substituted PES film was washed 3 times with fully demineralized water to make it neutral, boiled with fully demineralized water for about 30 minutes and dried in a vacuum drying cabinet at 20 mbar and 70° C. for approximately 1 hour.

A degree of substitution in the PES film of 0.3% was determined by ESCA. This means that 0.3% of all atoms at the surface of the PES film are iodine atoms.

The substituted PES film was then dissolved in DMSO-d₆ and a ¹H NMR spectrum was recorded. The spectrum shows peaks from 1,2,4-substituted aromatic moieties at 7.0 ppm and 6.95 ppm.

By derivatization of the substituted PES film with DAG and reaction of the derivative with ninhydrin, the substitution density per unit area was determined as 52 nmol of CH₂NH(O═C)—CH₂I/cm².

### EXAMPLE 6a

### Substitution of a PES Film with Iodoacetamide

A PES film was produced from a 25 wt. % solution of Ultrason E6020 (PES) in dimethyl sulfoxide.

0.92 g of iodoacetamide and then 0.1 g of paraformaldehyde were added to and dissolved in 50 ml of 80 wt. % H₂SO₄ at room temperature. Approximately 2 ml of the resulting solution was withdrawn into a pipette, from which it was dribbled evenly over both sides of a 10×10 cm piece of the PES film. The film treated in this way was heated under nitrogen for about 1 hour at 80° C. The substituted film was washed to make it neutral as in Example 6, boiled and dried.

A degree of substitution in the PES film of 0.1% to 0.15% was determined by ESCA. This means that 0.1% to 0.15% of all the atoms at the surface of the PES film are iodine atoms.

### EXAMPLE 6b

### Substitution of a PES Flat Membrane with Iodoacetamide

0.92 g of iodoacetamide and then 0.1 g of paraformaldehyde were added to and dissolved in 50 ml of 80 wt. % H₂SO₄ at room temperature. Approximately 2 ml of the resulting reaction solution was withdrawn into a pipette, from which it was dribbled evenly over both sides of a 10×10 cm piece of a PES flat membrane, available as Micro PES 2F from Membrana GmbH. The membrane treated in this way was heated under nitrogen at 80° C. for 1 hour. The substituted membrane was washed to make it neutral as in Example 6, boiled and dried.

A degree of substitution in the membrane of 0.1% to 0.15% was determined by ESCA. This means that 0.1% to 0.15% of all the atoms at the surface of the Micro PES 2F membrane are iodine atoms.

By derivatization of the substituted membrane with HMDA and reaction of the derivative with ninhydrin, the substitution density per unit area was determined as approx. 100 nmol of amino groups/cm², i.e., approx. 100 nmol of CH₂NH(O═C)—CH₂I/cm².

### EXAMPLE 7

### Substitution of a PES Film with Fluoroacetamide

A PES film was produced from a 25 wt. % solution of Ultrason E6020 (PES) in dimethylacetamide.

2.7 g of fluoroacetamide and then 0.35 g of paraformaldehyde were added to and dissolved in 35 ml of 80 wt. % H₂SO₄ at room temperature. A 50 cm² piece of the above PES film was laid in the resulting reaction solution. The PES film was treated with the reaction solution with stirring and at a temperature of about 85° C. for about 6 hours.

The substituted PES film was washed 3 times with fully demineralized water to make it neutral, boiled for about 30 minutes with fully demineralized water, and dried in a vacuum drying cabinet at 20 mbar and 70° C. for approximately 1 hour.

A degree of substitution in the PES film of 0.2% was determined by ESCA. This means that 0.2% of all the atoms at the surface of the PES film are iodine atoms.

The substituted PES film was then dissolved in DMSO-d₆ and a ¹H NMR spectrum was recorded. The spectrum shows peaks from 1,2,4-substituted aromatic moieties at 7.0 ppm and 6.95 ppm.

By derivatization of the substituted PES film with DAG and reaction of the derivative with ninhydrin, the substitution density per unit area was determined as 52 nmol of CH₂NH(O═C)—CH₂F/cm².

### EXAMPLE 8a

### Substitution of a PES Flat Membrane with Iodoacetamide

6.7 g of iodoacetamide and then 0.35 g of paraformaldehyde were added to and dissolved in 35 ml of 80 wt. % H₂SO₄ at room temperature. A 50 cm² piece of a PES flat membrane with nominal pore size 0.2 μm was laid in the resulting reaction solution. This membrane is available as Micro PES 2F from Membrana GmbH. The PES flat membrane was treated with the reaction solution with stirring and at a temperature of about 85° C. for about 6 hours.

The substituted PES flat membrane was washed 3 times with fully demineralized water to make it neutral, boiled for about 30 minutes with fully demineralized water, and dried in a vacuum drying cabinet at 20 mbar and 70° C. for approximately 1 hour.

A degree of substitution in the PES flat membrane of 0.6% was determined by ESCA. This means that 0.6% of all the atoms at the surface of the PES flat membrane are iodine atoms.

The substituted PES flat membrane was then dissolved in DMSO-d₆ and a ¹H NMR spectrum was recorded. The spectrum shows peaks from 1,2,4-substituted aromatic moieties at 7.0 ppm and 6.95 ppm.

By derivatization of the substituted PES flat membrane with DAG and reaction of the derivative with ninhydrin, the substitution density per unit area was determined as 147 nmol of CH₂NH(O═C)—CH₂I/cm². A blank value of 25 nmol/cm², which is ascribed to reaction of the ninhydrin with the polyvinylpyrrolidone present in the membrane, must be subtracted from this value.

### EXAMPLE 8b

The PES flat membrane that was substituted with iodoacetamide and then reacted with diaminoguanidine in Example 8a is tested for its capacity to remove the AGE precursor methylglyoxal from PBS buffer (8 g/l NaCl, 2.9 g/l Na₂HPO₄.12H₂O and 0.2 g/l Na₂HPO₄; pH=7.4). The procedure is as described in Example 5 of WO 02/08301, reference to the disclosure of which is hereby explicitly made, with the difference that the PES flat membrane substituted with iodoacetamide and then reacted with diaminoguanidine is used, the result being that this membrane removed 71% of the methylglyoxal contained in the PBS buffer.

### EXAMPLE 9

### Substitution of a PES Capillary Membrane Bundle with Iodoacetamide

6.7 g of iodoacetamide and then 0.35 g of paraformaldehyde were added to and dissolved in 35 ml of 80 wt. % H₂SO₄ at room temperature. A bundle of 8 cm long PES capillary membranes was laid in the resulting reaction solution. Each capillary membrane in this bundle has an outer and an inner surface with a total area of 1.18 cm², a wall thickness of 35 μm and a lumen of 200 μm. These capillary membranes are available as DIAPES from Membrana GmbH. The reaction solution was allowed to react with the capillary membranes at a temperature of about 80° C. for about 6 hours.

The substituted PES capillary membranes were washed 3 times with fully demineralized water to make them neutral, boiled for about 30 minutes with fully demineralized water, and dried in a vacuum drying cabinet at 20 mbar and 70° C. for approximately 1 hour.

By derivatization of the substituted PES capillary membranes with DAG and reaction of the derivative with ninhydrin, the substitution density per unit length was determined as 1.38 nmol of CH₂NH(O═C)—CH₂I/cm.

1. A molded body containing a polyarylether, at the surface of which substituents of formula (I) 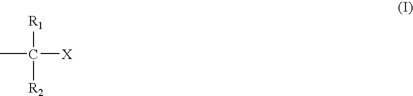
are bound, wherein R₁═H or an alkyl residue with 1 to 4 C atoms, R₂═H or an alkyl residue with 1 to 4 C atoms, and wherein X is a residue of formula (a) 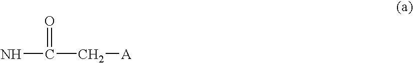
where A=F, Cl, Br or I or (CH₂)ₚCHNH₂—COOH with p=1 or 2, or
a residue of formula (b)
NH—(CH₂)ₙ—CH₂—Y (b)
where Y═H or NH₂ and n is an integer between 0 and 6, or
a residue of formula (c)
O—(CH₂)ₘCH₂-Z (c)
where Z=H, OH, COOH, NH₂, N-pyrrolidone or N-pyrrolidine and m is an integer between 1 and 5, or
a residue of formula (d) 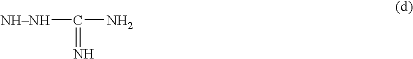
or
a residue of formula (e) 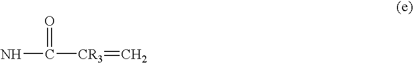
where R₃═H or CH₃, or
a residue of formula (f) 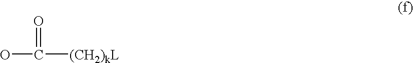
where L=COOH or NH₂ and k is an integer between 1 and 10, or
a residue of formula (g) 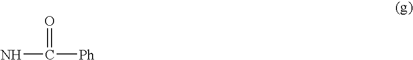
where Ph is an unsubstituted or pentahalogenated phenyl residue, or
a residue of formula (h)
O-G (h)
where G is a glucose residue or glucosamine residue.

2. The molded body according to claim 1, wherein R₁═R₂═H or R₁═R₂═CH₃ or R₁═H and R₂═CH₃.

3. The molded body according to claim 1, wherein the molded body is a powder.

4. The molded body according to claim 1 wherein the molded body is a hollow-fibre or a flat membrane.

5. The molded body according to claim 1I, wherein the polyarylether is a polysulfone, polyethersulfone, polyetherethersulfone, polyetherketone, polyetheretherketone or a copolymer of a preceding polymer.

6. The molded body according to claim 5, wherein the copolymer is a polyethersulfone/polyetherethersulfone copolymer.

7. A method of producing a molded body containing a substituted polyarylether, comprising dissolving an agent of formula H-X in aqueous H₂SO₄ to form a solution, wherein X is a residue of formula (a) 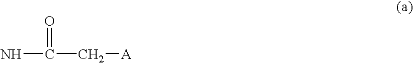
where A=F, Cl, Br or I or (CH₂)ₚCHNH₂-COOH with p=1 or 2, or
a residue of formula (b)
NH—(CHC—Y (b)
where Y═H or NH_and n is an integer between 0 and 6, or
a residue of formula (c)
O—(CH₂)ₘCH₂—Z (c)
where Z=H, OH, COOH, NH₂, N-pyrrolidone or N-pyrrolidine and m is an integer between 1 and 5, or
a residue of formula (d) 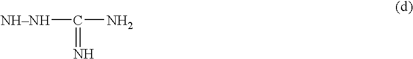
or
a residue of formula (e) 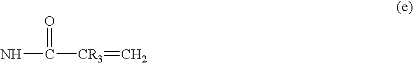
where R₃═H or CH₃, or
a residue of formula (f) 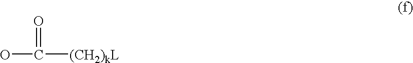
where L=COOH or NH₂ and k is an integer between 1 and 10, or
a residue of formula (g) 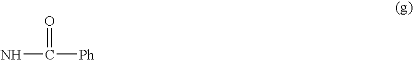
where Ph is an unsubstituted or pentahalogenated phenyl residue, or
a residue of formula (h)
O-G (h)
where G is a glucose residue or glucosamine residue, dissolving in the solution a carbonyl compound of formula (I) 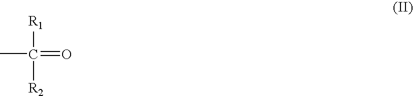
or a linear or cyclic ether of formula (III) a) or (III) b) 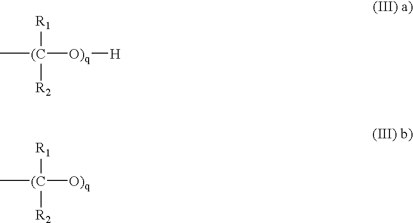
where q=3 to about 10000,
wherein R₁═H or an alkyl residue with 1 to 4 C atoms, R₂═H or an alkyl residue with 1 to 4 C atoms, to give a reaction solution, and treating a body containing a polyarylether with the reaction solution.

8. The method according to claim 7, wherein the carbonyl compound is formaldehyde or acetaldehyde.

9. The method according to claim 7, wherein the ether is paraformaldehyde or trioxane.

10. The method according to claim 7, wherein the agent of formula H—X is fluoroacetamide, chloroacetamide, iodoacetamide, hexylamine, hexamethylene diamine, aminoguanidine, ethanol, glucose, glucosamine, benzamide, pentafluorobenzamide, N-(2-hydroxyethyl)-pyrrolidone or N-(2-hydroxyethyl)-pyrrolidine.

11. The method according to claim 7, wherein a molded body that is in the form of a powder and contains the polyarylether is treated with the reaction solution.

12. The method according to claim 7, wherein a molded body that is in the form of a hollow-fiber or flat membrane and contains a polyarylether is treated with the reaction solution.

13. The method according to claim 11, wherein a molded body containing a polysulfone, polyethersulfone, polyetherethersulfone, polyetherketone, polyetheretherketone or a copolymer of the preceding polymers is treated with the reaction solution.

14. The method according to claim 13, wherein the copolymer is a polyethersulfone/polyetherethersulfone copolymer.

15. The method according to claim 7, wherein 60 to 93 wt. % aqueous H₂SO₄ is used.

16. The method according to claim 7, wherein the agent H—X is dissolved in H₂SO₄ in such quantities that the molar ratio of H—X to H₂SO₄ lies between 0.05 and 0.5.

17. The method according to claim 7, wherein formaldehyde or trioxane or paraformaldehyde, as pure material in each case, is dissolved in the solution containing H—X and aqueous H₂SO₄.

18. The method according to claim 7, wherein formaldehyde or trioxane or paraformaldehyde and H—X are used in such quantities that the molar ratio of formaldehyde or {O—CH₂} to H—X lies between 0.1 and 1.0.

19. The method according to claim 7, wherein formaldehyde or trioxane or paraformaldehyde and H₂SO₄ are used in such quantities that the molar ratio of formaldehyde or —(O—CH₂)— to H₂SO₄ lies between 0.001 and 0.50.

20. The method according to claim 7, wherein the reaction solution is prepared at room temperature.

21. The method according to claim 7 wherein the polyarylether molded body is treated with the reaction solution at a temperature between 30° C. and the boiling point of the reaction solution.

22. The molded body according to claim 1, wherein the molded body ha s a substituent of formula (I) (a) or (D) (b) with the exception of Y═H, or (1) (c) with the exception of Z=H, or (I) (f), and wherein the molded body is configured for adsorption chromatography.

23. The molded body according to claim 1, wherein the molded body has a substituent of formula (I) (a), such that the molded body reacts with a nucleophile.

24. The molded body according to claim 23, wherein the nucleophile is an aliphatic amine, diaminoguanidine, an amino acid, a peptide or an alcohol.

25. The molded body according to claim 1, wherein the molded body has a substituent of formula (I) (d) and is an anion exchanger.

26. The molded body according to claim 1, wherein the molded body has a substituent of formula (I) (e), and wherein the molded body is configured for graft copolymerization.

27. The molded body according to claim 1, wherein the molded body has a substituent of formula (I) (g) or of formula (I) (b) with Y═H, which provides the molded body with increased hydrophobicity.

28. The molded body according to claim 1, wherein the molded body has a substituent of formula (I) (h), which provides the molded body with increased hydrophilicity, or which reacts with cyanogen bromide.
